(19) United States
(12) Patent Application Publication
(10) Pub. No.: US 2012/0319991 A1
(43) Pub. Date: Dec. 20, 2012

(54) CAPACITIVE TYPE TOUCH PANEL

(75) Inventors: Chung Mo Yang, Gyunggi-do (KR); Sang Su Hong, Gyunggi-do (KR); Jae Hun Kim, Seoul (KR); In Hyung Lee, Gyunggi-do (KR); Woo Jin Lee, Seoul (KR); Young Woo Lee, Gyunggi-do (KR)

(73) Assignee: SAMSUNG ELECTRO-MECHANICS CO., LTD., Gyunggi-do (KR)

(21) Appl. No.: 13/425,737

(22) Filed: Mar. 21, 2012

(30) Foreign Application Priority Data
Jun. 14, 2011 (KR) 1020110057640

(51) Int. Cl. G06F 3/044

(52) U.S. Cl. 345/174

(57) ABSTRACT

Disclosed herein is a capacitive type touch panel, including: a sensing electrode formed on one surface of a first transparent substrate and having a mesh structure where a plurality of openings with a width of 2X are surrounded by patterned lines; and a driving electrode formed on one surface of a second transparent substrate, which faces the surface of the first substrate, and having a mesh structure where a plurality of openings with a width of 2X are surrounded by patterned lines in a region corresponding to the sensing electrode and a plurality of openings with a width of X are surrounded by patterned lines in the other region.

### CROSS REFERENCE TO RELATED APPLICATION

This application claims the benefit of Korean Patent Application No. 10-2011-0057640, filed on Jun. 14, 2011, entitled “Capacitive Type Touch Panel”, which is hereby incorporated by reference in its entirety into this application.

### BACKGROUND OF THE INVENTION

1. Technical Field

The present invention relates to a capacitive type touch panel.

2. Description of the Related Art

As computers using digital techniques develop, computer assisted devices have also correspondingly been developed, and personal computers, portable transmission apparatus, other personal information processing apparatus, or the like perform text and graphic processes using various input devices, such as a keyboard or a mouse.

With the rapid advancement of an information-oriented society widening the use of computers more and more, the problems come alight in that it is difficult to efficiently operate products using only the keyboard and mouse as being currently responsible for the input device function. Thus, the demand for a device that is simple, has minimum malfunction, and has the capability to easily input information is increasing.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display device including a liquid crystal display (LCD), a plasma display panel (PDP), an electroluminescence (El) element, or the like, or a cathode ray tube (CRT), so that a user selects desired information while viewing the image display device.

The touch panel is classifiable as a resistive type, a capacitive type, an electromagnetic type, a surface acoustic wave (SAW) type, and an infrared type. The type of touch panel selected is one that is adapted for an electronic product in consideration of not only signal amplification problems, resolution differences and the degree of difficulty of designing and manufacturing technology but also in light of optical characteristic, electrical properties, mechanical properties, resistance to the environment, input properties, durability and economic benefits of the touch panel. In particular, resistive and capacitive types are prevalently used in a broad range of fields currently.

First, the resistive type touch panel has a structure in which upper/lower transparent electrode films are disposed to be spaced by a spacer and be contacted with each other by a touch. In the resistive type of touch panel, when an upper touch panel formed with the upper transparent electrode film is pressed by an input unit such as fingers, pens, or the like, the upper/lower transparent electrode films are conducted and a change in voltage according to a change in resistance value in the position is recognized by a controller, such that the touched coordinates are recognized. As the resistive type of touch panel, there are a digital resistive type of touch panel and an analog resistive type of touch panel.

In the capacitive touch panel, the upper substrate on which the first electrode pattern is formed and the lower substrate on which the second electrode pattern is formed are spaced from each other and an insulator is inserted therebetween to prevent the first electrode pattern from contacting the second electrode pattern. In addition, the upper substrate and the lower substrate are formed with electrode wirings connected to the electrode patterns. The electrode wirings transfers the change in capacitance generated in the first electrode pattern and the second electrode pattern according to the touch of the input unit with the touch screen to a controller.

In the prior art, indium tin oxide (ITO) or a conductive polymer such as polyethylene dioxythiophene/polystyrenesulfonate (PEDOT/PSS) was used to form transparent electrodes. ITO has excellent electric conductivity, but a raw material thereof, that is, indium is rare earth metal and thus expensive, and besides, it is expected to be run out in 10 years and thereby supply and demand will not be smooth. The conductive polymer, which is a material substituting for ITO, has excellent flexibility and easy processability, but it has decreased electric conductivity.

For this reason, studies for forming a transparent electrode by using metal have been progressed. The transparent electrode formed of metal has more excellent electric conductivity and more smooth supply and demand, as compared with ITO or the conductive polymer. However, the transparent electrode formed of metal is problematic in view of transparency of a touch panel due to opaque metal color. Therefore, studies for improving visibility of the touch panel by forming the transparent electrode in a mesh structure are being progressed.

### SUMMARY OF THE INVENTION

The present invention has been made in an effort to provide a capacitive type touch panel having excellent electric conductivity and improved visibility by involving a mesh structure of transparent electrode.

According to a preferred embodiment of the present invention, there is provided a capacitive type touch panel, including: a sensing electrode formed on one surface of a first transparent substrate and having a mesh structure where a plurality of openings with a width of 2X are surrounded by patterned lines; and a driving electrode formed on one surface of a second transparent substrate, which faces the surface of the first substrate, and having a mesh structure where a plurality of openings with a width of 2X are surrounded by patterned lines in a region corresponding to the sensing electrode and a plurality of openings with a width of X are surrounded by patterned lines in the other region.

The sensing electrode and the driving electrode may be disposed crossing each other such that a center of the opening in the mesh structure of the sensing electrode is positioned at a cross point of the patterned lines in the mesh structure of the driving electrode.

The sensing electrode and the driving electrode may be formed of metal.

The metal may be copper (Cu), aluminum (Al), gold (Au), silver (Ag), nickel (Ni), or chrome (Cr).

The driving electrode and the sensing electrode each may have a sheet resistance 150Ω/□ or lower.

The touch panel may have a transmittance of 88% or higher.

According to another preferred embodiment of the present invention, there is provided a capacitive type touch panel, including: a sensing electrode formed on one surface of a transparent substrate and having a mesh structure where a plurality of openings with a width of 2X are surrounded by patterned lines; and a driving electrode formed on the other surface of the transparent substrate and having a mesh structure where a plurality of openings with a width of 2X are surrounded by patterned lines in a region corresponding to the sensing electrode and a plurality of openings with a width of X are surrounded by patterned lines in the other region.

The sensing electrode and the driving electrode may be disposed crossing each other such that a center of the opening in the mesh structure of the sensing electrode is positioned at a cross point of the patterned lines in the mesh structure of the driving electrode.

The sensing electrode and the driving electrode may be formed of metal.

The metal may be copper (Cu), aluminum (Al), gold (Au), silver (Ag), nickel (Ni), or chrome (Cr).

The driving electrode and the sensing electrode each may have a sheet resistance 150Ω/□ or lower.

The touch panel may have a transmittance of 88% or higher.

### BRIEF DESCRIPTION OF THE DRAWINGS

FIG. 1 is a cross-sectional view of a capacitive type touch panel according to a first preferred embodiment of the present invention;

FIG. 2 is a plan view of a first transparent substrate having a mesh structure of sensing electrode;

FIG. 3 is an enlarged view of part A in FIG. 2 showing the mesh structure of sensing electrode;

FIG. 4 is a plan view of a second transparent substrate having a mesh structure of driving electrode;

FIG. 5 is an enlarged view of part B in FIG. 4 showing the mesh structure of driving electrode;

FIG. 6 is a cross-sectional view of a capacitive type touch panel according to a first preferred embodiment of the present invention;

FIG. 7 is an enlarged view of part C of FIG. 6; and

FIG. 8 is a cross-sectional view of a capacitive type touch panel according to a second preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

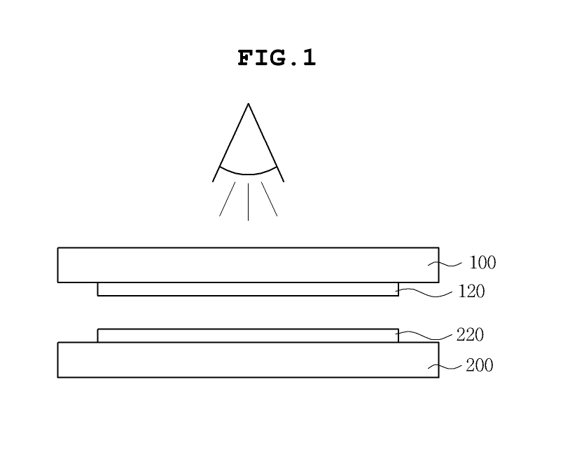

A capacitive type touch panel according to the present invention, as shown in FIG. 1, includes a sensing electrode 120 having a mesh structure and a driving electrode 220 having a mesh structure. The sensing electrode 120 having a mesh structure is formed on one surface of a first transparent substrate 100 and has a plurality of openings with a width of 2X surround by patterned lines. The driving electrode 120 having a mesh structure is formed on one surface of a second transparent substrate 200, which faces the surface of the first transparent substrate. The mesh structure of the driving electrode 220 has a plurality of openings with a width of 2X surrounded by patterned lines in a region thereof corresponding the sensing electrodes 120 and a plurality of openings with a width of X surrounded by patterned lines in the other region thereof.

The present invention is a mutual capacitive type touch panel, and a principle thereof is that a user touch point is measured through a change of capacitance, which is generated between the sensing electrode 120 and the driving electrode 220 when a voltage is applied to the driving electrode 220. The driving electrode 220 is formed in a mesh structure such that the openings in a partial region thereof have a different width from the openings in the other region thereof. As a result, an overlapping area of the sensing electrode 120 and the driving electrode 220 and a non-overlapping area of the sensing electrode 120 and the driving electrode 220 have the same optical characteristic when the touch panel is assembled. Therefore, the touch panel has an overall uniform mesh structure, when frontally viewed to a user, and thus, visibility of the touch panel can be improved. Hereinafter, the touch panel will be described in detail according to the components thereof.

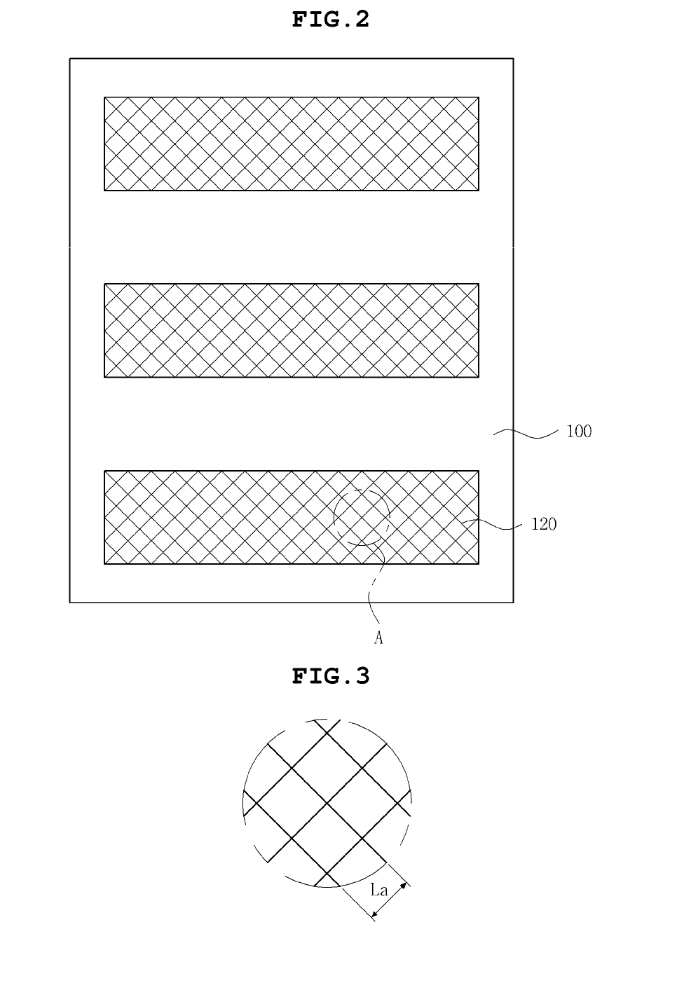

First, the sensing electrode 120 is formed in a mesh structure on one surface of the first transparent substrate 100, as shown in FIG. 2. The sensing electrode 120, which is a part for sensing user touch, is extended in one direction on the first transparent substrate 100 to have a patterned shape. The reason is that, if a region where the sensing electrode 120 is formed has a large area, sheet resistance thereof becomes large, resulting in a reduction in the touch sensing speed and an increase in power consumption, in the touch panel.

As such the sensing electrode 120 is formed in a mesh structure, and in this case, the mesh structure refers to a shape where a plurality of square openings surrounded by patterned lines are uniformly arranged with respect to a predetermined area, as shown in FIG. 3. In the mesh structure, if a thickness and a width of the patterned line are minutely set to several micrometers, an opening ratio (ratio of an opening area over the overall area) can reach 95% to 99.5%. As such, transmittance (ratio of transmitting light over incident light) of the touch panel can be raised by increasing the opening ratio of the mesh structure. Meanwhile, a width (See, La in FIG. 3) between the patterned lines of the sensing electrode 120 according to the present invention has a size of 2X. Here, the width (La) between the patterned lines refers to a length of one side of the square opening shown in FIG. 3.

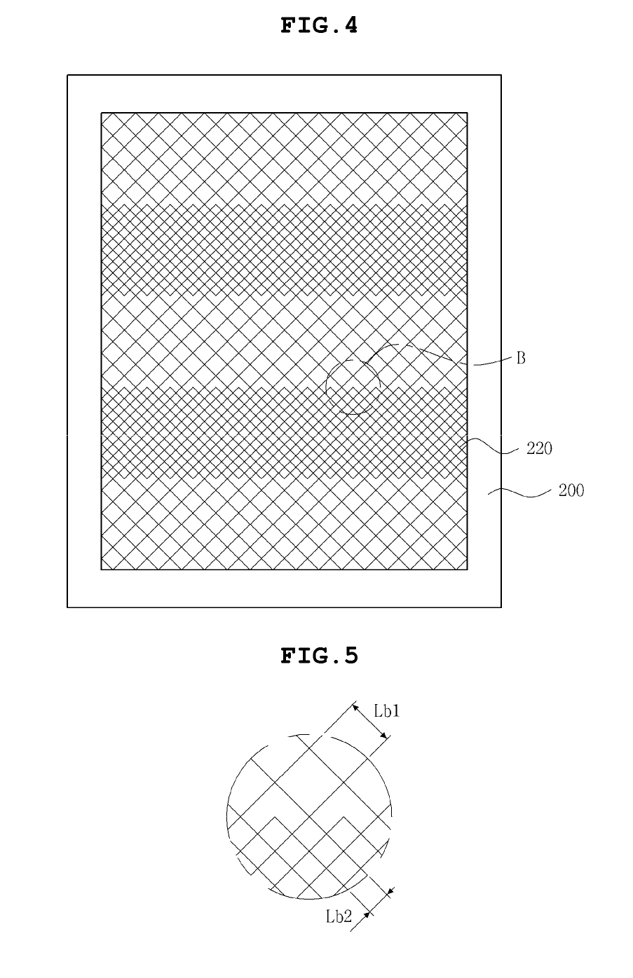

Next, the driving electrode 220 of the present invention, as shown in FIG. 4, is formed on one surface of the second transparent substrate 200 in a mesh structure, and positioned to face the sensing electrode 120 of the first transparent substrate 100 (See, FIG. 1). The driving electrode 220 is connected to a voltage source through wiring, and when a voltage is applied to the driving electrode 220, an electric field is generated between the driving electrode 220 and the sensing electrode 120. The driving electrode 220 is formed more widely than the sensing electrode 120. The reason is that noises or electromagnetic waves such as EMI emitted from a display are blocked so that they do not influence the sensing electrode 120.

The mesh structure of the driving electrode 220 will be described with reference to FIGS. 4 and 5. The mesh structure of the driving electrode 220 includes a plurality of openings with a width (Lb₁) of 2X surrounded by patterned lines in a region thereof corresponding to the sensing electrodes 120 (see, FIG. 2) and a plurality of openings with a width (Lb₂) of X surrounded by patterned lines in the other region thereof. In other words, as shown in FIG. 4, the mesh structure, where sizes of the openings are different according to the sensing electrodes 120 (see, FIG. 2), is repeatedly shown. In other words, when the surface of the first transparent substrate 100 having the sensing electrode 120 formed thereon and the surface of the second transparent substrate 200 having the driving electrode 220 formed thereon are bonded to face each other (see, FIG. 1), the width (Lb₁) of the opening in one region of the driving electrode 220, which faces a part of the first transparent substrate 100 where the sensing electrode 120 is formed, is larger than the width (Lb₂) of the opening in the other region of the driving electrode 220. Therefore, the region of the driving electrode 220, which has openings with the larger size, may have various shapes, such as, a bar shape, a diamond shape, a circular shape, an elliptical shape, and the like, according to the patterned shape of the sensing electrode 120.

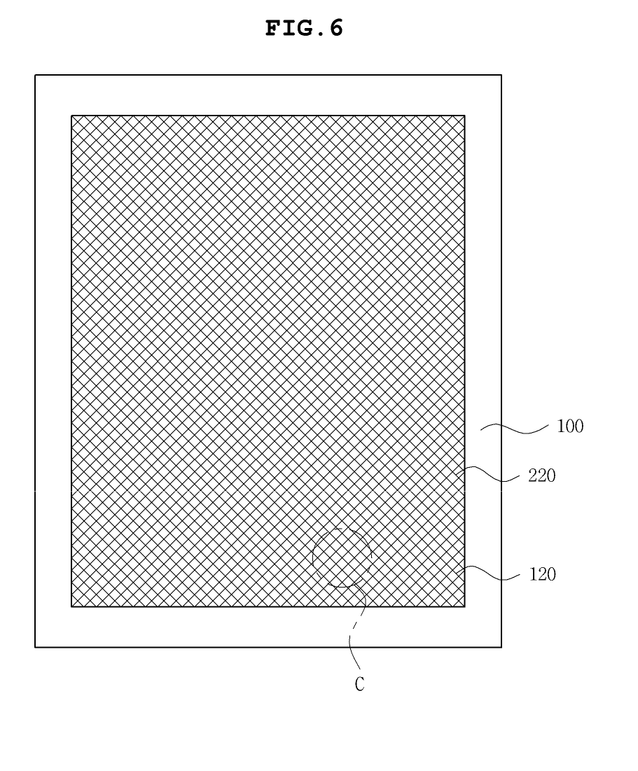

As shown in FIG. 5, the opening in the region of the driving electrode 220, which corresponds to the sensing electrode 120, is two times wider than the opening in the other region of the driving electrode 220. When the touch panel is viewed to a user while the first transparent substrate 100 and the second transparent substrate 200 are bonded, an overlapping area of the sensing electrode 120 and the driving electrode 220 is relatively smaller than a non-overlapping area of the sensing electrode 120 and the driving electrode 220 in view of an opening ratio of the mesh structure in a case where openings of the driving electrode 220 having a mesh structure have overall the same size, like in the prior art, or the opacity of the mesh structure is relatively increased enough to be visible to the naked eye in a case where patterned lines of the sensing electrode 120 completely overlap the patterned lines of the driving electrode 220. Therefore, the overlapping area of the sensing electrode 120 and the driving electrode 220 has relatively reduced transparency and transmittance and increased reflectance, which cause visibility of the touch panel to be deteriorated. According to the present invention, when the width (La) of the opening of the sensing electrode 120 and the width (Lb₁) of the opening in the region of the driving electrode 220, which corresponding to the sensing electrode, are 2X, they are formed to be two times larger than the width (Lb₂) of the opening in the other region of the driving electrode 220, which does not correspond to the sensing electrode, and thus, the overlapping area of the sensing electrode 120 and the driving electrode 220 is rendered the same as the non-overlapping area of the sensing electrode and the driving electrode in view of a density of the mesh structure. Therefore, when the touch panel is viewed to a user, as shown in FIG. 6, the mesh structure appears to be uniform, and thus, the touch panel has overall the same transparency, transmittance, and reflectance, thereby improving visibility thereof.

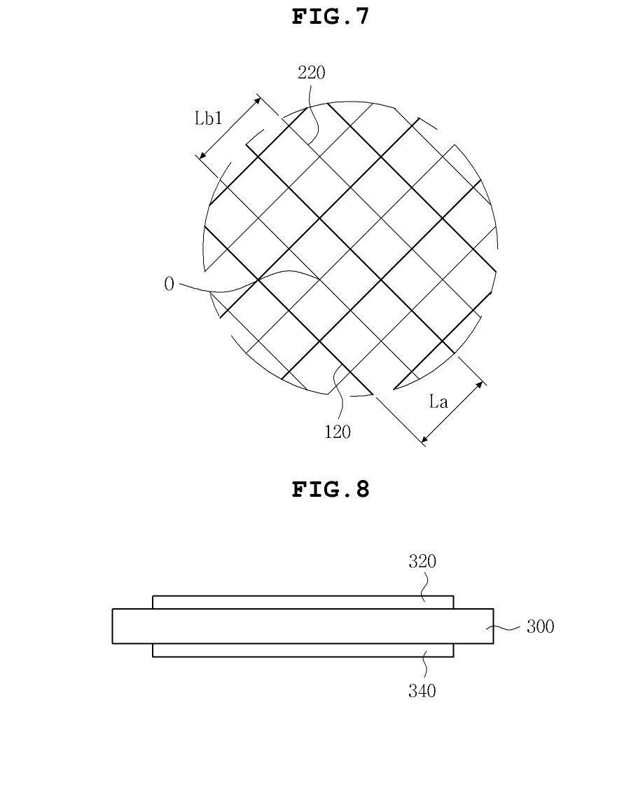

As shown in FIG. 7, the sensing electrode 120 and the driving electrode 220 may be disposed crossing each other such that a center of the opening in the mesh structure of the sensing electrode 120 is positioned at a cross point 0 of the patterned lines in the mesh structure of the driving electrode 220. That is, the cross point 0 at which two patterned lines in the mesh structure of the sensing electrode 120 cross each other is positioned at the center of the opening in the mesh structure of the driving electrode 220 correspondingly positioned. If the sensing electrode 120 and the driving electrode 220 are disposed as above, when viewed on the plane, the mesh structure appears to have openings with a width of X, thereby exhibiting the same optical characteristic as the region of the driving electrode 220, which does not overlaps the sensing electrode 120 and has openings with a width of X. Therefore, the transparency, transmittance, and reflectance can be equalized over all parts of the touch panel.

Meanwhile, the sensing electrode 120 and the driving electrode 220 are preferably formed of metal. The metal has higher electric conductivity and cheaper as compared with ITO or a conductive polymer. Examples of this metal may include copper (Cu), aluminum (Al), gold (Au), silver (Ag), nickel (Ni), or chrome (Cr). Preferably, copper (Cu), aluminum (Al), gold (Au), or silver (Ag), which has high electric conductivity, may be used. The metal may be applied onto the transparent substrate through plating, sputtering, evaporation, or the like, or the sensing electrode 120 and the driving electrode 220 may be formed by using a printing process, such as, silk screening, gravure printing, or inkjet printing. A material for the sensing electrode 120 and the driving electrode 220 is limited thereto, and any metal that can have high electric conductivity and easy processability may be used. The sensing electrode 120 and the driving electrode 220 may be formed by using ITO or a conductive polymer.

Meanwhile, when the sensing electrode 120 and the driving electrode 220 are formed of metal, the touch panel has lower transmittance due to the opaque color of the metal. However, if they are finely patterned in a mesh structure where a line width and thickness are in a range of several nanometers, the touch panel can have increased opening ratio and improved transmittance. As such, according to the present invention, high electric conductivity, such as, a sheet resistance of 150Ω/□ or lower, can be obtained by forming the sensing electrode 120 and the driving electrode 220 of metal having high-electric conductivity. In addition, the touch panel can have a transmittance of 88% or greater, thereby achieving excellent visibility, by forming the sensing electrode 120 and the driving electrode 220 in a mesh structure.

A touch panel according to a second preferred embodiment of the present invention, as shown in FIG. 8, may include a sensing electrode 320 with a mesh structure formed on one surface of a transparent substrate 300 and a driving electrode 340 with a mesh structure formed on the other surface of the transparent substrate 300. The sensing electrode 320 has a plurality of openings with a width of 2X surround by patterned lines. The driving electrode 340 has a plurality of openings with a width of 2X surrounded by patterned lines in a region thereof corresponding to the sensing electrodes 120, and a plurality of openings with a width of X surrounded by patterned lines in the other region thereof. The description of the part overlapped with the above-mentioned description will be omitted.

The touch panel according to this preferred embodiment of the present invention has a double-sided structure where the sensing electrode 320 is formed on one surface of the single transparent substrate 300 and the driving electrode 340 is formed on the other surface of the transparent substrate 300. That is, sensing and driving electrodes, which are respectively formed on two transparent substrates in the other cases, are formed on one transparent substrate 300, thereby achieving slimness of the touch panel. In addition, a thickness of the touch panel through which an image supplied from a display passes can be decreased, thereby improving visibility of the touch panel.

According to the present invention, as for transparent electrodes formed in a mesh structure, the mesh structure can be uniformly formed overall when the touch panel is assembled by making a width of each opening in a region of a driving electrode, which corresponds to a sensing electrode, two times larger than a width of each opening in the other region of the driving electrode, and disposing the openings of the driving electrodes crossing the openings of the sensing electrode. Therefore, an overlapping area and a non-overlapping area, of the sensing electrode and the driving electrode, have the same optical characteristic, thereby improving visibility of the touch panel.

Although the preferred embodiments of the present invention have been disclosed for illustrative purposes, they are for specifically explaining the present invention and thus the capacitive type touch panel according to the present invention is not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A capacitive type touch panel, comprising:
a sensing electrode formed on one surface of a first transparent substrate and having a mesh structure where a plurality of openings with a width of 2X are surrounded by patterned lines; and
a driving electrode formed on one surface of a second transparent substrate, which faces the surface of the first substrate, and having a mesh structure where a plurality of openings with a width of 2X are surrounded by patterned lines in a region corresponding to the sensing electrode and a plurality of openings with a width of X are surrounded by patterned lines in the other region.

2. The capacitive type touch panel as set forth in claim 1, wherein the sensing electrode and the driving electrode are disposed crossing each other such that a center of the opening in the mesh structure of the sensing electrode is positioned at a cross point of the patterned lines in the mesh structure of the driving electrode.

3. The capacitive type touch panel as set forth in claim 1, wherein the sensing electrode and the driving electrode are formed of metal.

4. The capacitive type touch panel as set forth in claim 3, wherein the metal is copper (Cu), aluminum (Al), gold (Au), silver (Ag), nickel (Ni), or chrome (Cr).

5. The capacitive type touch panel as set forth in claim 1, wherein the driving electrode and the sensing electrode each have a sheet resistance 150Ω/□ or lower.

6. The capacitive type touch panel as set forth in claim 1, wherein the touch panel has a transmittance of 88% or higher.

7. A capacitive type touch panel, comprising:
a sensing electrode formed on one surface of a transparent substrate and having a mesh structure where a plurality of openings with a width of 2X are surrounded by patterned lines; and
a driving electrode formed on the other surface of the transparent substrate and having a mesh structure where a plurality of openings with a width of 2X are surrounded by patterned lines in a region corresponding to the sensing electrode and a plurality of openings with a width of X are surrounded by patterned lines in the other region.

8. The capacitive type touch panel as set forth in claim 7, wherein the sensing electrode and the driving electrode are disposed crossing each other such that a center of the opening in the mesh structure of the sensing electrode is positioned at a cross point of the patterned lines in the mesh structure of the driving electrode.

9. The capacitive type touch panel as set forth in claim 7, wherein the sensing electrode and the driving electrode are formed of metal.

10. The capacitive type touch panel as set forth in claim 9, wherein the metal is copper (Cu), aluminum (Al), gold (Au), silver (Ag), nickel (Ni), or chrome (Cr).

11. The capacitive type touch panel as set forth in claim 7, wherein the driving electrode and the sensing electrode each have a sheet resistance 150Ω/□ or lower.

12. The capacitive type touch panel as set forth in claim 7, wherein the touch panel has a transmittance of 88% or higher.
